(19) United States
(12) Patent Application Publication
(10) Pub. No.: US 2017/0317891 A1
(43) Pub. Date: Nov. 2, 2017

(54) NEURON SYSTEM BASED ON INTERNET OF THINGS AND COMMUNICATION NETWORK, AND NEURON DEVICE THEREOF

(71) Applicants: ZHENGFANG MA, SHANGHAI (CN); YINING MA, SHANGHAI (CN); YECHI MA, SHANGHAI (CN)

(72) Inventors: ZHENGFANG MA, SHANGHAI (CN); YINING MA, SHANGHAI (CN); YECHI MA, SHANGHAI (CN)

(21) Appl. No.: 15/531,391

(22) PCT Filed: Dec. 1, 2015
(86) PCT No.: PCT/CN2015/096103

§ 371 Date: May 26, 2017

(30) Foreign Application Priority Data
Dec. 2, 2014 (CN) 201410719978.3

(51) Int. Cl. H04L 12/24; H04L 29/08; H04W 4/00

(52) U.S. Cl. CPC H04L 41/16; H04W 4/005; H04L 67/10; H04L 67/12

(57) ABSTRACT

Disclosed are a neuron system based on an internet of things and a communication network, and a neuron device thereof, which integrate resources of the internet of things and the communication network, thereby improving the degree of utilization of data collected by a sensor, reducing manufacturing costs of mobile terminals, and improving the utilization efficiency of resources. The present invention has the technical solution that the system comprises a sensor actuator, an internet of things, a communication network, a cloud server and a neuron device, wherein the sensor actuator collects information about an induction object; the neuron device conducts direct data communication with the sensor actuator and conducts, as a dynamic mobile node in the communication network, information interaction with the cloud server through the communication network; and the cloud server conducts information transmission with various neuron devices in the communication network and uniformly stores and processes information uploaded by the neuron device.

### FIELD OF INVENTION

This invention relates to a neuron system, more particular, to a neuron system between a neuron device and a cloud server, and comprising a sensor actuator and a communication network (including the internet and wireless network) of an internet of thing.

### DESCRIPTION OF RELATED ARTS

Herein a sensor network or a radio frequency identification device (RFID) network is equal to an internet of things. Actually either a sensor technique or a RFID technique is only one of information acquisition techniques. Besides the sensor and RFID techniques, techniques such as GPS, video identification, infrared, laser, scanning and so on, which enable to implement automatic identification and thing-to-thing communication, are all able to be the information acquisition techniques of the internet of things. The sensor network or the RFID network is only an application of the internet of things, but absolutely not whole of the internet of things.

After long development, each device of the internet network has respective IP address. Meanwhile communication of machine-to-machine (M2M) is also updating; and information interaction and processing can be taken between the devices without personnel participation.

One of terminals of the internet of things is just an electrical appliance or a similar device we daily used. These “things” communicate each other through infrastructure or a backbone network linked by communication standards such as ZigBee, Sub-GHz, Wi-Fi or PLC. However, main connection devices in the internet of things are arranged at a node called “last inch” of the network. These nodes include: a micro-programmed control unit (MCU), a wireless device, a sensor and an actuator, which are a brain, an eye and a finger of the internet of things respectively.

The internet of things does not aim to establish connection between a user and a device, because the user does not hope to monitor sensors spread all over a house and sensors spread all over a manufacturing process all the time. The internet of things aims not only to collect important information but also inter-communicate among the devices and make important decisions.

Challenges for implementing applications of inter-connection of devices for the internet of things are totally different from challenges for the traditional network connection devices. For example, manufacturers of lighting and household appliances have to introduce new network, wireless and embedded software techniques in addition to essential functions into their products. Furthermore, because the device usually cannot be connected to the power supply, its power-supply efficiency is also very important; so that the device may employ an energy collecting apparatus or a battery to work for several years without maintenance or exchanging of battery.

Developers also need to consider other relative factors, such as cost, the number of elements, performance of MCU, system scale, standard, interoperability, safety, usability and elimination ability of a field failure and so on. Finally, a software shall be able to bridge a device and collect data from sensors, and then to display information on a displayer for a user in a visual way, or to transmit the information to the user's computer, tablet or cellphone.

A smart meter is a typical example of the application of the internet of things. Except for simply measuring the power dissipation, the smart meter enables instant communication between an electric power company and a client, for actively shutting down a high-load appliance during peak energy period for saving electric charge of the user and easing the burden of the electric power company. In fact, the smart meter is only one of the applications of the internet of things for a smart house. The internet of things may not only bring advantages to industrial automation, lighting control, smart house, security and monitoring, health and health care, and agricultural applications, but also appear in a wearable application area rising recently.

Nowadays, applications of the internet of things (sensors related) and internet applications (internet terminals related) cannot combine together quite well. Information collected by the sensors is very hard to be absorbed and utilized by the internet applications via effective and convenient technical methods.

On the other hand, functions of current internet terminals (mobile terminals such as a cellphone and so on) are increasing complex, many applications, processing and computing are implemented on the terminals independently. However, this kind of implementation obviously increases production cost of the terminal, but also wastes resource due to independent computing and processing of the individual terminal.

### SUMMARY OF THE PRESENT INVENTION

Hereinafter one or some aspects of brief overview are provided for fundamental understanding of these aspects. The overview is not aiming to provide detailed description of each aspect of all conceptions, or to identify essential or conclusive elements, or to define scope of any one of or all of aspects. The only purpose is to provide one or some aspects of conceptions in a simplifying form as a preface of the more detailed description further provided.

A purpose of this invention is to solve the abovementioned problems and to provide a neuron system based on an internet of things and a communication network and a neuron device thereof, which integrate resources of the internet of things and the communication network, increase utilization degree of information collected by sensors, decrease production cost of a mobile terminal, and improve utilization efficiency of the resources.

The technical scheme of this invention is that: a neuron system based on an internet of things and a communication network of the invention is characterized by comprising: a sensor actuator, an internet of things, a communication network, a cloud server and a neuron device, wherein:

the sensor actuator collects information about an induction object;

the neuron device conducts direct data communication with the sensor actuator, and serves as a dynamic mobile node in the communication network to conduct information interaction with the cloud server through the communication network;

the cloud server conducts information transmission with each neuron device, stores and processes information uploaded from the neuron device uniformly.

In one implementation according to the neuron system based on the internet of things and communication network of this invention, the sensor actuator comprises a sensor and a plurality of switch modules.

In one implementation according to the neuron system based on the internet of things and communication network of this invention, the neuron device comprises: a micro-processor, a receiving module, a transmitter module, an input interface, an output interface, and a storage module, wherein, the input interface and output interface are data transmission channels not only between the neuron device and the cloud server but also between the neuron device and an external input device; the receiving module and the transmitter module are information transmission channels among the neuron device, the cloud server and the sensor actuator; the storage module is used for storing data downloaded from the cloud server and/or data collected from each sensor actuator; the micro-processor is connected to the receiving module, the transmitter module, the input interface, the output interface and the storage module through a system bus for controlling the modules and the interfaces.

In one implementation according to the neuron system based on the internet of things and communication network of this invention, the sensor actuator further comprises a wireless transceiver module which enables to send read information to a corresponding neuron device according to a mobile communication protocol.

In one implementation according to the neuron system based on the internet of things and communication network of this invention, the neuron device further comprises a sensor actuator interface, through which the neuron device is directly connected to the sensor actuator and conducts direct information interaction with the sensor actuator.

In one implementation according to the neuron system based on the internet of things and communication network of this invention, the receiving module of the neuron device receives information collected by the sensor actuator and stores the information in the storage module; the transmitter module of the neuron device sends a control instruction including an adjustment of an implementation threshold value of the sensor actuator to the corresponding sensor actuator.

In one implementation according to the neuron system based on the internet of things and communication network of this invention, the cloud server receives information from the neuron device and sensor actuator, processes the received information uniformly, and then sends back processed results to the corresponding neuron device and sensor actuator.

In one implementation according to the neuron system based on the internet of things and communication network of this invention, each sensor actuator is configured to have an unique IP address respectively, through which the cloud server and the neuron device enable to access the corresponding sensor actuator.

In one implementation according to the neuron system based on the internet of things and communication network of this invention, the neuron device further comprises a call-to-autorun module which enables to launch an auto-call when the information of the corresponding sensor actuator received by the neuron device exceeds a preset threshold value, and to auto-upload corresponding information to the cloud server for the cloud server making a decision based on the information.

In one implementation according to the neuron system based on the internet of things and communication network of this invention, each neuron device is configured to have an individual IP address; the cloud server is composed of a plurality of virtual hosts with a respective IP address, wherein the access between each virtual host and the corresponding neuron device is completed through the respective IP address; the access among various neuron devices is completed through the respective IP address.

This invention further discloses a neuron device comprising: a micro-processor, a receiving module, a transmitter module, an input interface, an output interface, and an storage module, wherein, the input interface and output interface are a data transmission channels not only between the neuron device and the cloud server but also between the neuron device and an external input device; the receiving module and transmitter module are information transmission channels among the neuron device, the cloud server and each sensor actuator; the storage module is used for storing data downloaded from the cloud server and/or data collected from each sensor actuator; the micro-processor is connected to the receiving module, the transmitter module, the input interface, the output interface and storage module through a system bus for controlling the modules and the interfaces.

In one implementation according to the neuron device of this invention, the sensor actuator comprises a sensor and a plurality of switch modules.

In one implementation according to the neuron device of this invention, the receiving module of the neuron device receives information collected by the sensor actuator and stores the information in the storage module; the transmitter module of the neuron device sends a control instruction including an adjustment of an implementation threshold value of the sensor actuator to the corresponding sensor actuator.

In one implementation according to the neuron device of this invention, the neuron device further comprises a call-to-autorun module which enables to launch an auto-call when the information of the corresponding sensor actuator received by the neuron device exceeds the preset threshold value, and to auto-upload the corresponding information to the cloud server for the cloud server making a decision based on the corresponding information.

In one implementation according to the neuron device of this invention, the neuron device further comprises a sensor actuator interface, through which the neuron device is directly connected to the sensor actuator and conducts direct information interaction with the sensor actuator.

In one implementation according to the neuron device of this invention, each neuron device is configured to have a respective IP address; the cloud server accesses the neuron device through the corresponding IP address; the access among various neuron devices is completed through the corresponding IP address.

As compared to the prior art, this invention has following beneficial effects: the invention integrates the internet of things and the communication network together, allocates a respective IP address for each sensor actuator in the internet of things and each neuron device in the communication network, enables the cloud server to access the sensor actuator and the neuron device through the IP address, enables the neuron device to access the sensor actuator directly through a wireless network or a physical interface, and enables the access among the neuron devices through the IP address. For example, the sensor actuator may upload the information collected by the built-in wireless transceiver module to the neuron device directly. The neuron device may also import the data of the sensor actuator through a physical form interface of the sensor actuator. Comparing to the traditional technique, this invention establishes an effective communication bridge between the internet of things and the communication network, which enables the information collected by the sensor actuator to be well utilized by the neuron device in the communication network; and by means of the cloud server, the complicated computations and processes on these information can be transferred to the cloud server for uniform operation, namely, value-increasing applications are transferred to the cloud server, thereby reducing burden of the neuron device arranged on the terminal, solving disadvantages brought by increasing complication of the terminal, and enabling more complicating application to be implemented on a terminal with simple functions. The combination of the neuron device (a terminal) and the sensor actuator (such as a wearable device), together with the assistance of the cloud server for complication processing, is capable for achieving various applications, helping the development of the wearable devices, facilitating surfing the internet by a mobile object at any time, and increasingly lowering the cost of the mobile terminal with the high integration of the device.

### BRIEF DESCRIPTION OF THE DRAWINGS

FIG. 1 illustrates a system principle diagram of a preferable embodiment of the neuron system based on an internet of things and a communication network according to this invention.

FIG. 2 illustrates a structure diagram of a preferable embodiment of the neuron device according to this invention.

FIG. 3 illustrates a system principle diagram of another embodiment of the neuron system according to this invention.

### DETAILED DESCRIPTION OF THE PREFERRED EMBODIMENTS

After reading detail descriptions of embodiments in this disclosure incorporated with appending drawings, a better understanding of the characteristics and advantages mentioned above of this invention could be achieved. In the appending drawings, each component may not be drawn to scale and the components with similar related features or characteristics may be marked with the same or approximate reference signs.

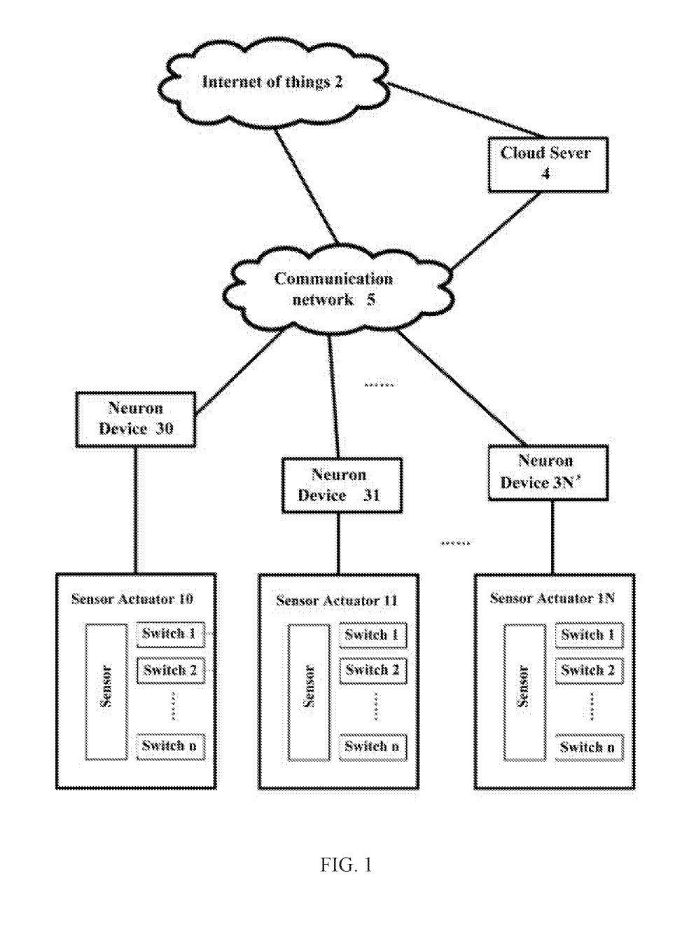

FIG. 1 illustrates a system principle diagram of a preferable embodiment of the neuron system based on an internet of things and a communication network according to this invention. Referring to FIG. 1, a neuron system of this embodiment comprises: a plurality of sensor actuators 10˜1N, a plurality of neuron devices 30˜3N′, a cloud server 4, an internet of things 2 and a communication network 5. The communication network 5 may be the internet, a mobile communication network such as a 3G, 4G and the like, a wireless communication network such as a WiFi and the like.

In this system, the sensor actuators 10˜1N collect information about an induction object and upload the information to the corresponding neuron devices 30˜3N′. The cloud server 4 arranged in the communication network 5 conducts direct data communication with the neuron devices 30˜3N′, uniformly stores and processes information uploaded by the neuron devices 30˜3N′. The information uploaded by the neuron devices includes information collected from the sensor actuators and input information from outside.

The neuron devices 30˜3N′ serve as dynamic mobile nodes of the communication network 5, and conduct information interaction with the cloud server 4 through the communication network 5.

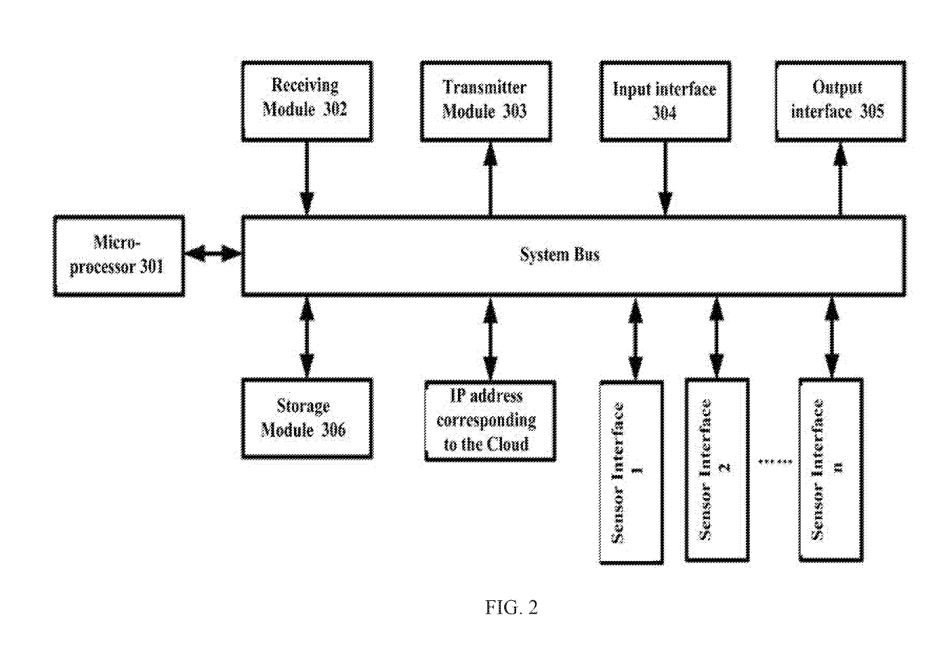

FIG. 2 illustrates a structure diagram of a preferable embodiment of the neuron device according to this invention. Please refer to FIG. 2. The neuron device 30 (one of the neuron devices 30 is taken as an example for illustration, the other neuron devices have the same structure) comprises: a micro-processor 301, a receiving module 302, a transmitter module 303, an input interface 304, an output interface 305, and a storage module 306. Wherein, the input interface 304 and the output interface 305 are data transmission channels not only between the neuron device 30 and the cloud server 4 but also between the neuron device 30 and an external input device (not shown). The receiving module 302 and the transmitter module 303 are information transmission channels among the neuron device 30, the cloud server 4 and each of the sensor actuators 10˜1N. The storage module 306 is used for storing data downloaded from the cloud server 4 and/or data collected from each of the sensor actuators 10˜1N. The micro-processor 301 is respectively connected to the receiving module 302, the transmitter module 303, the input interface 304, the output interface 305 and the storage module 306 through a system bus 307 for controlling these modules and interfaces.

The neuron device serves as an internet hub for a person and a mobile object and a value-increasing application is transferred to the corresponding cloud server, thereby enabling function simplification, terminal instrumentation and cloud computation of the mobile neuron device.

The receiving module 302 of the neuron device receives the information collected from the sensor actuators, and stores the collected information in the storage module 306. The transmitter module 303 of the neuron device transmits control instructions to the corresponding sensor actuator, wherein the control instructions include an adjustment of an implementation threshold value of the sensor actuator. What is stored in the storage module 306 includes recorded static and dynamic information of each of the sensor actuators; and the neuron device may directionally send the information stored in the storage module 306 to a specified IP address, wherein the information includes the recorded static information, dynamic information, and changes of threshold values, etc., of each of the sensor actuators.

A communication between the neuron device 30 and the sensor actuator 10 may have both wireless and physical interface modes. In the wireless mode, a wireless transceiver module (not shown) is provided in the sensor actuator 10, and the collected information is sent to the neuron device 30 according to a mobile communication protocol.

In the physical interface mode, an interface of the sensor actuator 309 (or more) is provided in the neuron device 30, through which the neuron device 30 is directly connected to the sensor actuator and conducts direct data interaction with the sensor actuator. Of course, the sensor actuator may also be built-in the neuron device 30.

The sensor actuator includes a component of sensor itself, and further a plurality of switches (e.g., the Switch 1 to Switch n shown in the Figures).

Preferably, the neuron device 30 further comprises a call-to-autorun module 308, which enables to launch an auto-call when the information of the corresponding sensor actuator received by the neuron device exceeds a preset threshold value, and further auto-upload the corresponding information to the cloud server 4 for the cloud server 4 making a decision based on the corresponding information.

In the internet of things, each of the sensor actuators 10˜1N is configured to have an individual IP address, the cloud server 4 and the neuron device 30˜3N′ access the sensor actuators 10˜1N through the configured IP address. Besides, each of the neuron devices 30˜3N′ is configured to have an individual IP address, the cloud server 4 accesses the neuron devices 30˜3N′ through the IP address, and the accesses among different neuron devices 30˜3N′ are completed through the IP addresses (e.g., for reading information from a storage module of another neuron device). The cloud server 4 receives and uniformly processes information from the neuron devices 30˜3N′ and information from the sensor actuators 10˜1N′, and sends processed results back to the corresponding neuron devices 30˜3N′ and sensor actuators 10˜1N′. In addition to building communication connection with the neuron devices and the sensor actuator through the communication network 5, the cloud server 4 may build communication connection with the internet of things directly.

Preferably, the cloud server 4 is composed of a plurality of virtual hosts with a respective IP address, wherein each of the virtual hosts corresponds to one neuron device to accomplish necessary value-added application. Each virtual host accesses the corresponding neuron device through the respective IP address. The value-added applications of the neuron device are all carried out based on the corresponding virtual host. The neuron device is only used as a neuron device for data read-in, data read-out, data collection and publication (published to the cloud or other authorized mobile terminals and neuron devices), data caching, data monitoring, communicating with other neuron devices and real-time or periodically transmitting data to the cloud. All the advanced computations, analysis and value-added applications are accomplished by the virtual host corresponding to the cloud.

A core component of an intelligent wearable device is a computer which may surf the internet at any time. However, there is a contradiction between the requirement for increasing strong functions of a local computer to meet increasing complex needs and the requirement for portability of the wearable device. When the internet speed of a mobile network reaches a certain degree, one solution for the above problems is to employ a high-speed mobile network to merely take the neuron device as an internet hub, an output-input device and a caching device, and to employ the cloud server to complete all complicated computation, which enables to solve the problems mentioned above quite well.

Because the neuron devices with simplified function serve as one's internet hub, data from various sensors on one's body and various data of one's body may be transmitted to the virtual host of the cloud by the neuron devices in real time, the virtual host enables to complete various kinds of value-added applications, send results back to the neuron devices through the mobile network, and then distribute the results to each part of body. For instance, the results are distributed to eyes for viewing, learning or playing, to muscle for muscle status reminder, to earphones for enjoying music and language, and to every sense organ of the body for experiencing virtual reality.

Information exchange of mobile objects, e.g., information exchange between the mobile object with an object, a person and a network, fails to adequately use the mobile network. By installing an instrumentalized neuron device in a mobile object as the internet hub, it may not only send information of the mobile object to a person, an object or a network in time, but also carry out value-added applications for completing complicated analysis and computation immediately, so as to improve and develop applications of the internet of things.

Because the neuron device with simplified functions greatly decreases cost of the neuron device without limiting its powerful computing capability, the neuron device may be widely applied in various movable objects, to collect data from various sensor actuators on various objects for a long time, and to proceed immediate and long-term accumulated analysis and computation, and then to promote applications of big data.

From this scheme, one can see that the neuron device may be used as a node equipment of various wireless networks. As a dynamic mobile node in a dynamic wireless network, the neuron device establishes a protocol (at the place where an operator's mobile network could not cover and a communication mechanism could be established with these nodes). As long as the mobile neuron device approaches the “nodes”, the neuron device could read data in the nodes, store the data in its storage module and automatically send the data to an assigned IP address when there is a network communication.

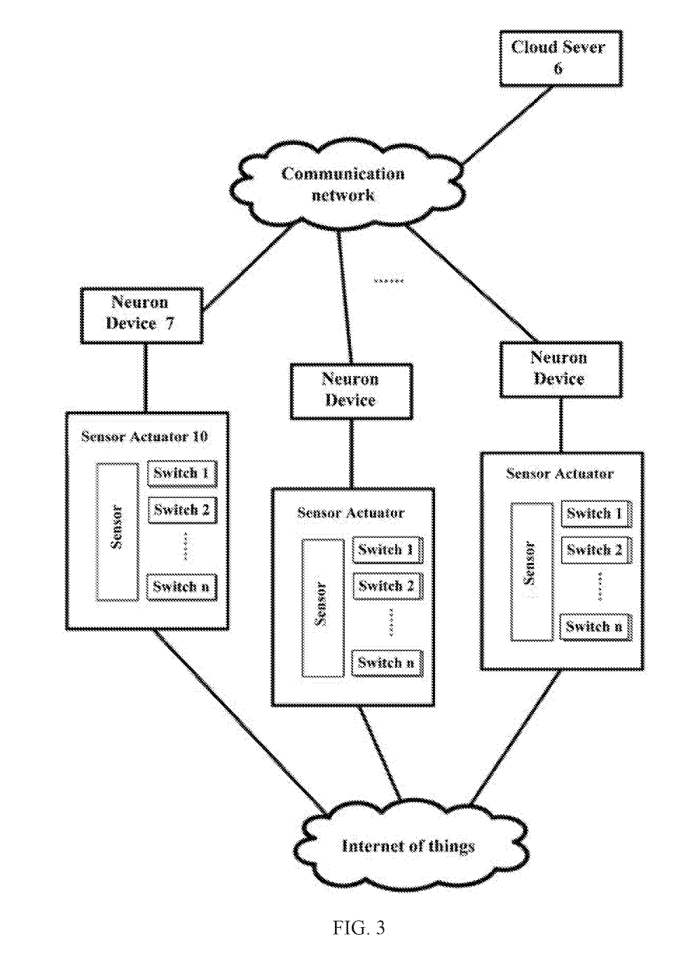

FIG. 3 is shown another structure of the system. The difference between the implantations in FIG. 3 and FIG. 1 lies in the position of the internet of things; in FIG. 3, the sensor actuators may further establish communication connections therebetween through the internet of things.

Following are embodiments of applications according to this invention.

### Embodiment 1

A neuron device is installed in a vehicle (such as a car, a ship and an aircraft). An input interface of the neuron device accesses a station announce button of a bus driver to dispatch (their neuron device) to broadcast manual (subjectively judged by the bus driver) location information for the passengers inside or outside the bus through the neuron device.

The neuron device in the bus (such as via a position sensor actuator) establishes auto-call mechanism with the neuron device (such as via a position sensor actuator) carried by the passengers, confirms dynamic busload of the vehicle and reports to a person, an object or an institute as needed. The position sensor actuator in the bus periodically sends position information of the bus to those who reserves this information through the neuron device; the person who reserves position information of the bus may actively call the neuron device in the bus to inquire position information of the bus. The person who reserves information could be family relation who cares the geographic position of a private car, could be a passenger who cares specific geographic position information of coming bus, or could be a logical company who cares geographic position information of cargo transportation monitored.

Analogy can be made to a temperature sensor actuator of an engine of a vehicle to monitor the security status of the engine, and the like.

### Embodiment 2

A neuron device is installed on human's wearing clothes. When the aged or a kid goes out, the neuron device periodically sends position information from a position sensor actuator on their clothes to a preset terminal. The preset terminal could actively call to inquire the position information.

A sensor actuator monitoring health status (such as a pulse and blood pressure sensor actuator) periodically sends monitoring information to a subscriber through a personal neuron device. The subscriber may also calls through the terminal to inquire real-time data of the sensor actuator.

A neuron device of a patient (such as a position sensor actuator) and a neuron device of a doctor (such as a position sensor actuator) establish an auto-call mechanism therebetween, by which the doctor automatically sends medical records and medical files to the patient, and the patient sends his/her own medical records, files and personal medical examination to the doctor.

Although for simplifying explanation, the methods mentioned above are graphically illustrated and described as a series of actions, it should be understood and comprehend that these methods are limited by the sequences of actions, because according to one or more embodiments, some actions could occurs in different sequences and/or at the same time with other actions shown and described or not shown or described in this specification but understood by the skilled in the art.

Those persons skilled in the art shall further understand that the combination of all kinds of explanatory logical modules, modules, circuits, and algorithm steps from the embodiments disclosed in this specification could implement as an electronic hardware, a computer software or the combination thereof. To clearly explain the interchangeability between the software and the hardware, various explanatory components, blocks, modules, circuits and steps are generally described above in their function forms. Whether the kind of function is implemented as a hardware or a software depends on the specific application and design limitation applied to the entire system. Those persons skilled in the art could take different ways to implement the described function for every specific application, however this implementation strategy shall not be explained to apart from the scope of this invention.

The various explanatory logical modules, modules, and circuits described in combination with the embodiments disclosed in this specification could be implemented or operated by general processors, digital signal processors (DSP), application specific integrated circuits (ASIC), field programmable gate arrays (FPGA) or other programmable logic devices, discrete gates or transistor logic, discrete hardware components, or any other designed combination of functions described in this specification. The general processor may be a micro-processor, and in an alternative solution, the processor could be any general processor, controller, micro-controller, or state machine. The processor could be further implemented as combination of computing devices, for instance, a combination of a DSP and a micro-processor, multiple micro-processors, one or some micro-processors cooperated with a DSP core, or any other devices with similar configuration.

Steps combined with the methods or algorithms described in the embodiments disclosed in this specification could be reflected directly in the hardware, in the software module operated by a processor, or a combination thereof. The software module could reside in a RAM memory, a flash memory, a ROM memory, a EPROM memory, a EEPROM memory, a register, a hard disk, a removable disk, CD-ROM, or storage medium of any other forms known in this field. An exemplary storage medium is coupled to a processor so as to enable the processor to read/write information from/to the storage medium. In an alternative solution, a storage medium could be combined with the processor. The processor and the storage medium could reside in ASIC. The ASIC could reside in a user's terminal. In an alternative solution, a processor and a storage medium could be separate component residing in a user's terminal.

In one or more exemplary embodiments, the described functions may be implemented in the hardware, software, firmware or any combination thereof. If the functions are implemented as computer programming products in software, every function could be one or more instructions or codes stored in or transmitted by the computer readable medium. The computer readable medium includes a computer storage medium and a communication medium, including any medium facilitating to transmit computer programs from one place to another place. The storage medium could be any usable medium which is able to be accessed by the computer. As examples but not limitations, this kind of computer readable medium includes RAM, ROM, EEPROM, CD-ROM or other optical storage, disk storage or other magnetic storage, or any other medium enabled to be accessed by a computer and to be carried-on or to store instructions or appropriate programming codes in data structure form. For example, if the software is transmitted through a coaxial cable, an optical cable, a twisted pair, a DSL, or wireless techniques such as infrared, radio, and microwave from websites, servers, or other remote sources, then the coaxial cable, optical cable, twisted pair, DSL, or wireless techniques such as infrared, radio, and microwave should be included in definition of the medium. For instance the disk and disc used in this specification include a compact disc (CD), a laser disc, an optical disk, a digital video disk (DVD), a floppy disk and a blu-ray disc, wherein the disk usually re-appears data via a magnetic way and the disc re-appears data by laser via an optical way. The combination of the above shall also be included in the scope of the computer readable medium.

The description of this disclosure is provided for those skilled in the art to manufacture or use this invention. All kinds of modifications of this disclosure could be obvious for those skilled in the art, and the general principle defined in this specification could be applied to other changes but not apart from spirit or scope of this disclosure. Therefore, this disclosure does not aim to be limited in the examples and designs described in this specification, but aim to be granted the widest scope consistent with the principle and novelty features disclosed in this specification.

What is claimed is:

1. A neuron system based on an internet of things and a communication network, comprising: a sensor actuator, an Internet of things, a communication network, a cloud server and a neuron device, wherein:
the sensor actuator collects information about an induction object;
the neuron device conducts direct data communication with the sensor actuator, and serves as a dynamic mobile node in the communication network to conduct information interaction with the cloud server through the communication network;
the cloud server conducts information transmission with each neuron device in the communication network, stores and processes information uploaded from the neuron device uniformly.

2. The neuron system based on the internet of things and the communication network of claim 1, wherein, the sensor actuator comprises a sensor and a plurality of switch modules.

3. The neuron system based on the internet of things and the communication network of claim 1, wherein, the neuron device comprising: a micro-processor, a receiving module, a transmitter module, an input interface, an output interface and a storage module, wherein, the input interface and the output interface are data transmission channels not only between the neuron device and the cloud server but also between the neuron device and an external input device; the receiving module and the transmitter module are information transmission channels among the neuron device, the cloud server and the sensor actuator; the storage module is used for storing data downloaded from the cloud server and/or data collected from each sensor actuator; the micro-processor is respectively connected to the receiving module, the transmitter module, the input interface, the output interface and the storage module through a system bus, for controlling the modules and interfaces.

4. The neuron system based on the internet of things and the communication network of claim 3, wherein, the sensor actuator further comprises a wireless transceiver module, which enables to send the read information to a corresponding neuron device according to a mobile communication protocol.

5. The neuron system based on the internet of things and the communication network of claim 1, wherein, the neuron device further comprises a sensor actuator interface, through which the neuron device is directly connected to the sensor actuator and conducts direct information interaction with the sensor actuator.

6. The neuron system based on the internet of things and the communication network of claim 3, wherein, the receiving module of the neuron device receives information collected by the sensor actuator and stores the information in the storage module; the transmitter module of the neuron device sends a control instruction including an adjustment of an implementation threshold value of the sensor actuator to the corresponding sensor actuator.

7. The neuron system based on the internet of things and the communication network of claim 1, wherein, the cloud server receives information from the neuron device and sensor actuator, processes the received information uniformly, and sends back processed results to the corresponding neuron device and sensor actuator.

8. The neuron system based on the internet of things and the communication network of claim 1, wherein, each sensor actuator is configured to have an individual IP address, through which the cloud server and the neuron device enable to access a sensor actuator.

9. The neuron system based on the internet of things and the communication network of claim 1, wherein, the neuron device further comprises a call-to-autorun module, which enables to launch an autocall when the information of the corresponding sensor actuator received by the neuron device exceeds a preset threshold value, and to auto-upload the related information to the cloud server for the cloud server making a decision based on the information.

10. The neuron system based on the internet of things and the communication network of claim 1, wherein, each neuron device is configured to have an individual IP address; the cloud server is composed of a plurality of virtual hosts with individual IP address, wherein the access between each virtual host and a corresponding neuron device is completed through the respective IP address; the access among different neuron devices is completed through the respective IP address.

11. A neuron device, comprising: a micro-processor, a receiving module, a transmitter module, an input interface, an output interface and a storage module, wherein, the input interface and the output interface are data transmission channels not only between the neuron device and the cloud server but also between the neuron device and an external input device; the receiving module and the transmitter module are information transmission channels among the neuron device, the cloud server and a plurality of sensor actuators; the storage module is used for storing data downloaded from the cloud server and/or data collected from each sensor actuator; the micro-processor is respectively connected to the receiving module, the transmitter module, the input interface, the output interface and the storage module through a system bus for controlling the modules and interfaces.

12. The neuron device of claim 11, wherein, the sensor actuator comprises a sensor and a plurality of switch modules.

13. The neuron device of claim 11, wherein, the receiving module of the neuron device receives information collected by the sensor actuator and stores the information in the storage module; the transmitter module of the neuron device sends a control instruction including an adjustment of an implementation threshold value of the sensor actuator to the corresponding sensor actuator.

14. The neuron device of claim 11, further comprising a call-to-autorun module, which enables to launch an autocall when the information of the corresponding sensor actuator received by the neuron device exceeds the preset threshold value, and to auto-upload the related information to the cloud server for the cloud server making a decision based on the information.

15. The neuron device of claim 11, further comprising a sensor actuator interface, through which the neuron device is directly connected to the sensor actuator and conducts direct information interaction with the sensor actuator.

16. The neuron device of claim 11, wherein, each neuron device is configured to have an individual IP address, the cloud server accesses the neuron device through the IP address and the access among various neuron devices is completed through the IP address.
